(19) United States
(12) Patent Application Publication
(10) Pub. No.: US 2013/0346161 A1
(43) Pub. Date: Dec. 26, 2013

(54) BENCHMARKING WITH PEER GROUPS IN A CLOUD ENVIRONMENT

(71) Applicant: Jochen Mayerle, Flein (DE)

(72) Inventor: Jochen Mayerle, Flein (DE)

(73) Assignee: SAP AG, Walldorf (DE)

(21) Appl. No.: 13/532,409

(22) Filed: Jun. 25, 2012

(51) Int. Cl. G06Q 10/06

(52) U.S. Cl. 705/7.39

(57) ABSTRACT

The embodiments provide a cloud server including a communication manager configured to receive information identifying a set of key performance indicators, over a network, from a benchmarking application associated with an enterprise having a plurality of business processes for which performance is to be benchmarked against a peer group, a peer group controller configured to receive peer group information, a data collector configured to collect first business data corresponding to the enterprise and second business data corresponding to at least one other enterprise according to the peer group information, and a root cause analyzer configured to analyze the first business data against the second business data and generate performance results based on the set of key performance indicators. The communication manager is configured to provide the performance results, over the network, to the benchmarking application for display.

### BACKGROUND

Enterprises are facing increasing competition in a more and more globalized economy, and may need to benchmark themselves on a regular basis with their peer group in order to find areas of further cost cutting or efficiency improvement. Benchmarking is the process of comparing one's business processes and performance metrics to industry bests or best practices from other industries. The dimensions typically measured may be quality, time and/or cost. In the process of benchmarking, management may identify the best firms in their industry, or in another industry where similar processes exist, and may compare the results and processes of those studied (the “targets”) to one's own results and processes. In this way, enterprises may learn how well the targets perform and, more importantly, the business processes that explain why these firms are successful.

Benchmarking may be considered a privilege of large enterprises, because only large companies have the capabilities in terms of resources to benchmark their performance on a global base against a peer group. However, even large companies are limited to competitor data from compulsory publications such as balance sheets, profit and loss statements from the Security Exchange Commission (SEC), or paid services from third party provides such as the Hackett Group or services from Enterprise Resource Planning (ERP) providers such as SAP. In addition, such enterprises are often forced to unveil and share their data to calculate key performance indicators (KPIs) not only with their peer group, but also from third party providers while both may have further interests in such data. In addition, most of the KPIs used in benchmarking are predefined such as Day Sales Outstanding, KPIs from a Supply Chain Operations Reference (SCOR) model or other well defined business KPIs, for example. However, conventional methods of benchmarking are not able to benchmark themselves against their peer group with self-defined KPIs or even to adjust the calculation logic of a business KPI to suit the customer's own needs.

In addition, benchmarking may be a time consuming, error-prone and expensive process. For example, all required information for benchmarking must be collected from an ERP system, which may involve relatively large amounts of data. Thus, the data collection process may take a considerable amount of time. Also, the information being collected from the ERP system is typically in paper format such as portable document format (PDF), which may be error prone. Further, enterprises may be skeptical of the data quality from the peer group because enterprises never fully know whether the data collection process was carried out by an expert or a student commissioned with data collection. Also, in the case of small companies, such benchmarking procedures are typically too expensive or require resources beyond the capabilities of a small company.

### SUMMARY

The embodiments provide a cloud server having a cloud benchmarking service. The cloud server includes a communication manager configured to receive information identifying a set of key performance indicators, over a network, from a benchmarking application associated with an enterprise having a plurality of business processes for which performance is to be benchmarked against a peer group, a peer group controller configured to receive peer group information identifying the peer group including at least one other enterprise in a same business area as the enterprise, a data collector configured to collect first business data corresponding to the enterprise and second business data corresponding to the at least one other enterprise from a database associated with the cloud benchmarking service according to the peer group information, and a root cause analyzer configured to analyze the first business data against the second business data and generate performance results based on the set of key performance indicators. The performance results provides performance data of the plurality of business processes in view of the peer group. The communication manager is configured to provide the performance results, over the network, to the benchmarking application for display.

According to one general aspect, the set of key performance indicators may include at least one self-defined key performance indicator. Also, the peer group information may include at least one of industry information specifying an industry, a Standard Industrial Classification (SIC) code, regional information specifying a region, country information specifying a country, peer information specifying one or more enterprises, and enterprise size information indicating a size of an enterprise for inclusion in the peer group.

According to a general aspect, the first business data may be stored in a first tenant database and the second business data may be stored in a second tenant database. The first and second databases may be separate databases.

The cloud server may further include a data anonymizer configured to anonymize the first business data and the second business data, and the root cause analyzer may be configured to analyze the anonymized first business data against the anonymized second business data.

The cloud server may further include a registration manager configured to register the enterprise with the cloud benchmarking service including storing registration information associated with the registered enterprise in a customer accounts database. Also, the cloud server may further include an impact analyzer configured to perform an impact analysis on the first business data in conjunction with additional business data received from the benchmarking application over the network. Further, the cloud server may further include a product suggestion unit configured to provide one or more software products for purchase, over the network, based on the performance results. In addition, the cloud server may include an in-memory database system including at least the data collector and the root cause analyzer.

The embodiments may also include a method for benchmarking performed by one or more processors in a cloud benchmarking service. The method may include receiving information identifying a set of key performance indicators, over a network, from a benchmarking application associated with an enterprise having a plurality of business processes for which performance is to be benchmarked against a peer group, receiving peer group information identifying the peer group including at least one other enterprise in a same business area as the enterprise, collecting first business data corresponding to the enterprise and second business data corresponding to the at least one other enterprise from a database associated with the cloud benchmarking service according to the peer group information, analyzing the first business data against the second business data, and generating performance results based on the set of key performance indicators, where the performance results provide performance data of the plurality of business processes in view of the peer group. The method further includes providing the performance results, over the network, to the benchmarking application for display.

The set of key performance indicators may include at least one self-defined key performance indicator. Also, the peer group information may include at least one of industry information specifying an industry, a Standard Industrial Classification (SIC) code, regional information specifying a region, country information specifying a country, peer information specifying one or more enterprises, and enterprise size information indicating a size of an enterprise for inclusion in the peer group.

The first business data may be stored in a first tenant database and the second business data may be stored in a second tenant database. The first and second databases may be separate databases.

The method may further include anonymizing the first business data and the second business data, wherein the analyzing step analyzes the anonymized first business data against the anonymized second business data, registering the enterprise with the cloud benchmarking service including storing registration information associated with the registered enterprise in a customer accounts database, performing an impact analysis on the first business data in conjunction with additional business data received from the benchmarking application over the network, and/or providing one or more software products for purchase, over the network, based on the performance results.

The embodiments may provide a computer program product tangibly embodied on a non-transitory computer-readable storage medium and including executable code that, when executed, is configured to cause a cloud server having a cloud benchmarking service to receive information identifying a set of key performance indicators, over a network, from a benchmarking application associated with an enterprise having a plurality of business processes for which performance is to be benchmarked against a peer group, receive peer group information identifying the peer group including at least one other enterprise in a same business area as the enterprise, collect first business data corresponding to the enterprise and second business data corresponding to the at least one other enterprise from a database associated with the cloud benchmarking service according to the peer group information, analyze the first business data against the second business data, generate performance results based on the set of key performance indicators, where the performance results provide performance data of the plurality of business processes in view of the peer group, and provide the performance results, over the network, to the benchmarking application for display.

The set of key performance indicators may include at least one self-defined key performance indicator. Also, the peer group information may include at least one of industry information specifying an industry, a Standard Industrial Classification (SIC) code, regional information specifying a region, country information specifying a country, peer information specifying one or more enterprises (1 through N), and enterprise size information indicating a size of an enterprise for inclusion in the peer group.

The details of one or more implementations are set forth in the accompanying drawings and the description below. Other features will be apparent from the description and drawings, and from the claims.

### BRIEF DESCRIPTION OF THE DRAWINGS

FIG. 1 illustrates a system for implementing a cloud benchmarking service according to an embodiment;

FIG. 2 is a flowchart illustrating example operations of the cloud benchmarking service of FIG. 1 according to an embodiment; and

FIG. 3 is a flowchart illustrating example operations of the cloud benchmarking service of FIG. 1 according to another embodiment.

### DETAILED DESCRIPTION

The embodiments provide a cloud benchmarking service that enables a user operating a benchmarking application executing on a remote device to benchmark business performance data in any application area on any level with a set of predefined or self-defined business key performance indicators (KPIs) against an arbitrary peer group. For example, the cloud benchmarking service may upload business data associated with an enterprise via automated data collection and aggregation techniques and then analyze the business data against previously uploaded business data from one or more other enterprises of a peer group to generate performance data in view of the peer group.

In particular, the cloud benchmarking service may perform a root cause analysis for over/under performance and optionally an impact analysis of KPI improvements. Also, the cloud benchmarking service may permit the user to define his/her own business KPIs with calculation logic associated with the cloud benchmarking service. The performance data may indicate whether the enterprise is under-performing or over-performing with respect to the peer group. Also, the cloud benchmarking service may leverage real-time analytics capabilities of in-memory technologies such as the HANA in-memory database system developed by SAP. Further, based on the performance data, the cloud benchmarking service may suggest additional products in order to improve performance in areas identified by the business analysis. Not only the user has the ability to purchase offered products, but products may be downloaded and implemented upon purchase. These and other features are further explained with reference to the figures.

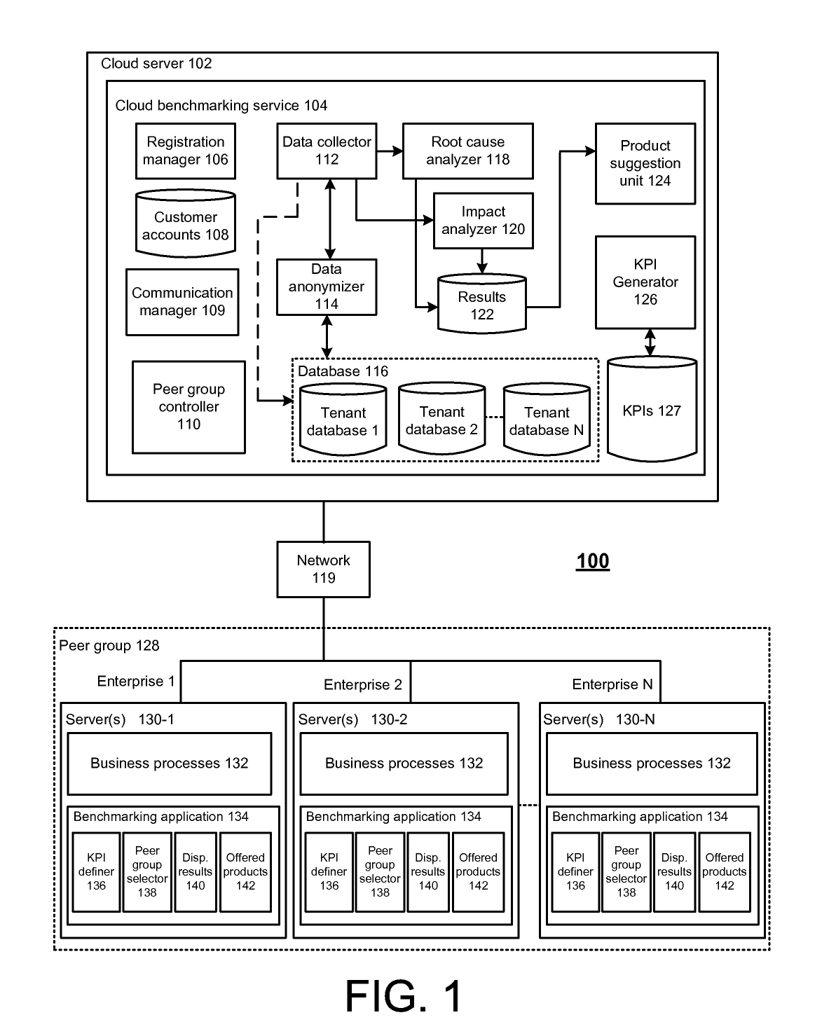

FIG. 1 illustrates a system 100 for implementing a cloud benchmarking service 104 according to an embodiment. As shown in the example of FIG. 1, the cloud benchmarking service 104 may be executed on a cloud server 102, which provides benchmarking capabilities over a network 119. As described in more detailed below, the cloud benchmarking service 104 may enable cloud benchmarking clients (e.g., enterprises 1 to N) to benchmark their performance against a peer group 128 using a set of predefined and/or self-defined business KPIs.

The peer group 128 may include a number of enterprises, e.g., enterprise 1 to enterprise N. Enterprises in the peer group 128 may have one or more similar business processes 132 or be enterprises in the same business area as each other. As further explained below, the peer group 128 may be selectable or adjustable by the user of the cloud benchmarking service 104 by industry, Standard Industrial Classification (SIC) code, region, country, size, and number/type of enterprises. Basically, the user has the capabilities of defining which enterprises to be included in the peer group 128 for benchmarking purposes, and the number of enterprises.

Generally, an enterprise may be a business organization or association that performs business processes 132. The business processes 132 may be any type of process related to business, e.g., a collection of related, structured activities or tasks that produce a specific service or product for a particular customer or customers. Further, an enterprise may be associated with one or more servers 130 in order to carry out the business processes 132. For example, enterprise 1 is associated with one or more servers 130-1, enterprise 2 is associated with one or more servers 130-2, and enterprise N is associated with one or more servers 130-N. The servers 130 may be configured and deployed according to techniques known in the art. The servers 130 may be any type of physical processing unit having a number of processors and memory units in order to carry out their respective business processes 132. The servers 130 and the business processes 132 are well known to one of ordinary skill in the art, and only the aspects relevant to the embodiments will be discussed herein.

According to the embodiments, the servers 130 associated with each enterprise may include a benchmarking application 134. For example, the enterprises illustrated in FIG. 1 have registered with the cloud benchmarking service 104, and for purposes of explanation, are included in the same peer group 128. However, it is understand that the cloud benchmarking service 104 may have a relatively large number of registered enterprises, and each enterprise may define its own peer group 128. In one example, enterprise 1 may register with the cloud benchmarking service 104, and then install the benchmarking application 134 to be operated by the user on the client-side. The benchmarking application 134 permits the user to communicate with the cloud benchmarking service 104 via the network 119.

For example, the benchmarking application 134 may operate in conjunction with a web browser. In this regard, the term “cloud” or “cloud-aware” references the use of “cloud computing,” which, generally speaking, includes a style of computing in which computing resources such as application programs and file storage are remotely provided over a network such as the Internet, typically through the web browser/benchmarking application 134. For example, many web browsers are capable of running applications, which can themselves be application programming interfaces (“API's”) to more sophisticated applications running on remote servers. In the cloud computing paradigm, a web browser interfaces with and controls an application program that is running on a remote server. Through the browser, the user can create, edit, save and delete files on the remote server (e.g., the cloud server 102) via the remote application program, e.g., benchmarking application 134. Thus, it may be observed that the cloud server 102 and the benchmarking application 134 may also represent examples of cloud computing. The network 119 may be the public Internet or other wide area public or private network such as a corporate or other intranet, and/or a smaller-scale, local or personal network, any of which may be implemented using standard network technology.

Generally, the benchmarking application 134 may include a KPI definer 136, a peer group selector 138, displayed results 140, and offered products 142. However, the benchmarking application 134 may include other aspects or functionalities that are either described herein or known to one of ordinary skill in the art. The KPI definer 136 may allow the user to define his/her own KPIs and/or select a set of predefined KPIs stored on the cloud server 102. For example, if the user wishes to define his/her own KPIs, the KPI definer 136 may present the user with an interactive interface for entering the relevant KPI information in order to create the desired KPIs. Then, the KPI definer 136 may transmit the KPI information to the cloud benchmarking service 104 in order to generate the user-defined KPIs. Also, the KPI definer 136 may present one or more pre-defined KPIs to the user for selection. Upon selection of the relevant predefined KPIs, the KPI definer 136 may transmit information regarding the KPI selection to the cloud benchmarking service 104. Also, the embodiments encompass any combination of predefined and self-defined KPIs for inclusion as the set of KPIs to be used in the benchmarking process.

The peer group selector 138 provides the user with an interface to enter information regarding the peer group 128 to be evaluated against. For example, the peer group selector 138 may receive peer group information via the interface, and transmit the peer group information to the cloud benchmarking service 104. The peer group information may specify the enterprises to be included in the peer group 128. In one example, the peer group information may include industry information specifying an industry, an SIC code, regional information specifying a region, country information specifying a country, peer information specifying one or more enterprise (1 through N), and/or enterprise size information indicating a size of enterprise for inclusion in the peer group. Based on the peer group information, the cloud benchmarking service 104 may define the peer group 128.

Thereafter, the cloud benchmarking service 104 may upload business data associated with the enterprise according to the selected/defined KPIs, and compare the uploaded data against the business data previously uploaded for the enterprises in the peer group 128 according to the calculation logic dictated by the relevant KPIs. Business data may refer to any type of data associated with a business. For example, business data may include documents relating to sales, manufacturing, accounting, employees, products, or any type of area associated with a business. Further, the business data may include customer data, sales information, and/or any other data information considered as part of the business processes 132.

In one example, an enterprise (e.g., Enterprise 1) may wish to evaluate the performance of its business processes 132 against other enterprises in the peer group 128. After receiving/determining the peer group information and the set of KPIs, the cloud benchmarking service 104 may collect first business data corresponding to the enterprise and second business data corresponding to the other enterprises in the peer group, and analyze the first business data against the second business data and generate performance results based on the set of KPIs selected/defined by the user. The performance results may provide performance data of the business processes 132 in view of the peer group 128. Then, the benchmarking application 134 may receive the performance results, over the network 119, to be displayed as the displayed results 140. Further, based on the performance results, the benchmarking application 134 may provide one or more offered products 142 (e.g., for purchase) in order to improve performance in areas identified by the business analysis.

Referring to FIG. 1, the cloud server 102 may include a number of example components or modules which may be utilized to implement functionalities of the cloud benchmarking service 104. For example, the cloud benchmarking service 104 may include a registration manager 106 for registering the enterprises for the cloud benchmarking service 104. The registration manager 106 may receive registration information over the network 119 that signs up a particular enterprise (e.g. Enterprise 1-N) for use of the cloud benchmarking service 104. The registration manager 106 may store customer identification information, or any other type of customer information in a customer accounts database 108. For instance, the customer accounts database 108 may store customer information such as customer identification numbers, customer names, location information, as well as any other type of information typically included in a customer account. The registration manager 106 may also create a tenant database for the newly registered cloud benchmarking client, which may store the uploaded business data and other information related to the benchmarking process. Also, by registering with the cloud benchmarking service 104, the registered enterprise may provide permission that other participating customers can access its data (e.g., anonymous data) for benchmarking purposes.

A communication manager 109 may manage the communication between the enterprises 1-N and the cloud benchmarking service 104. For example, the communication manager 109 may include one or more APIs designed to communicate with the benchmarking application 134 over the network 119 according to a cloud communication protocol, which may be implemented according to any known cloud implementation techniques. The messages exchanged, over the network 119, between the cloud benchmarking service 104 and the benchmarking application 134 may be enabled by the communication manager 109. In one example, the communication manager 109 may receive information, over the network 119, identifying a set of KPIs from the KPI definer 136 of the benchmarking application 134.

As indicated above, via the KPI definer 136, a user may select a set of predefined KPIs and/or define his/her own KPIs. For example, the KPI definer 136 may display a set of predefined KPIs, where the user may select one or more of the displayed KPIs to be used in the benchmarking evaluation. A KPI database 127 may store a plurality of available KPIs to be used in the benchmarking evaluations. Depending on a context of the business processes 132, the peer group 128 and/or the type of enterprise, a KPI generator 126 may select one or more of the predefined KPIs stored in the KPI database 127, and provide the selected KPIs, over the network 119, to be displayed by the KPI definer 136. Then, the user may select one or more of the displayed KPIs, and the KPI generator 126 may receive selection information, over the network 119, from the KPI definer 136, where the selection information indicates one or more selected KPIs. The KPI generator 126 may store the user's selection in the KPI database 127.

Also, the KPI definer 136 may provide an option for the user to create one or more self-defined KPIs. If the user selects this option, the KPI generator 126 may generate the user-defined KPI(s) based on information received via the KPI definer 136 as well as textual definitions and calculation rules associated with the KPI generator 126. In one embodiment, the KPI generator 126 may utilize an analytics tool for generating the user-defined KPI(s) such as the By Design Analytics Wizard developed by SAP. For example, the KPI definer 136 may present a series of interactive user-interfaces that guide the user in creating his/her own KPI(s). The KPI generator 126 may receive the KPI generation information, over the network 119, from the KPI definer 136, and generate the user-defined KPI(s) based on the KPI generation information and the calculation logic associated with the analytics tool. The KPI generator 126 may then store the user-defined KPIs in the KPI database 127.

A peer group controller 110 may control the peer group based on information provided through the peer group selector 138. For example, the peer group controller 110 may receive peer group information over the network 119 such as the industry information specifying an industry, the SIC code, the regional information specifying a region, the country information specifying a country, the peer information specifying one or more enterprises (1 through N), and/or the enterprise size information indicating a size of an enterprise for inclusion in the peer group. Based on the information provided through the peer group selector 138, the peer group controller 110 may define the peer group 128 for the enterprise to benchmark its business data against. In one example, the peer group controller 110 may receive the SIC code, over the network 119, from the peer group selector 138, and the peer group controller 110 may select enterprises having the same SIC code for inclusion in the peer group 128. Also, the user may have the ability to review the selected enterprises, and adjust (e.g., add, delete, change) the selected enterprises.

A data collector 112 may perform the replicate, aggregate, and collection functions associated with uploading the business data from the enterprises associated with the cloud benchmarking service 104. For example, the data collector 112 may collect the business data when a particular enterprise registers with the cloud benchmarking service 104 or at a later date when the enterprise is ready to have its data uploaded to the cloubed. According to one embodiment, the data collector 112 may store the collected data directly in a database 116.

For example, the database 116 includes a plurality of tenant databases 1-N. The tenant databases 1-N are the separate customer databases that store the enterprises' uploaded data. For instance, each tenant database may correspond to a different enterprise, and be separated according to tenant separation techniques known in the art. In one example, the tenant database 1 may store the business data associated with enterprise 1, the tenant database 2 may store the business data associated with enterprise 2, and the tenant database N may store the business data associated with enterprise N. As such, the data collector 112 may collect the business data associated with a particular enterprise, and store the collected business data in the tenant database associated with that enterprise. By storing business data in a separate tenant database, the customer may be assured of the integrity of its business data.

Also, because the uploaded business data may be relatively large, the system 100 may utilize an in-memory database system. For example, the in-memory database system may be a type of database system that supports real-time analytics and transactional processing including replication and aggregation techniques. The in-memory database systems may include a parallel processing data store that utilizes row-based, column-based, and/or object-based storage techniques. In one embodiment, the in-memory database system may be HANA Enterprise 1.0 (any other versions) that is developed by SAP.

In the context of benchmarking, the in-memory database system may include the functionality of the data collector 112, which may collect the business data associated with registered cloud benchmarking clients over the network 119. For example, the user may identify all business data relevant to the business processes 132 to be used in the benchmarking analysis. For instance, the data collector 112 may interactively guide the user in identifying the appropriate documents and information required for the benchmarking analysis. Then, the data collector 112 may upload the business data from the registered enterprise, and store the collected business data in the appropriate tenant database. Also, any analytical calculations (e.g., root cause analysis, impact analysis) may be performed by the in-memory database system, thereby increasing the speed associated with the benchmarking process.

Alternatively, before the uploaded data is stored in the appropriate tenant database within the database 116, a data anonymizer 114 may be configured to anonymize the uploaded data. For example, the data anonymizer 114 may anonymize the data after the data collector 112 collects the data, and then may store the anonymized data in the appropriate tenant database. In particular, the data anonymizer 114 may protect the identity of the enterprise by removing any references to the source, e.g., making the anonymized data impossible (or nearly impossible) to trace. The data anonymizer 114 may utilize data anonymizing techniques that are well known to one of ordinary skill in the art.

As indicated above, the cloud benchmarking service 104 may analyze the business data against the business data of the peer group 128 according to the selected/defined set of KPIs. For example, a root cause analyzer 118 may be configured to analyze the business data of the enterprise against the business data of the peer group 128 and generate performance results based on the set of KPIs. The root cause analyzer 118 may utilize any type of root cause analysis technique in the context of benchmarking known to one of ordinary skill in the art. For example, for each KPI, the root cause analyzer 118 may analyze the business data against the business data of the peer group 128, and generate performance results charactering the performance of the business processes 132 such as the under-performance and/or over-performance in relation to the peer group 128. In one example, the data collector 112 and/or root cause analyzer 118 may obtain the set of KPIs from the KPI database 127, and then obtain the relevant business data from the tenant databases necessary to perform the root cause analysis for each KPI. Then, the root cause analyzer 118 may perform the root cause analysis on the obtained business data as specified by the set of KPIs.

Optionally, an impact analyzer 120 may be configured to perform an impact analysis on the business data associated with the enterprise in conjunction with additional business data received from the benchmarking application 134 over the network 119. For example, a cloud benchmarking client may enter and/or release additional business data into the database 116, and the impact analyzer 120 may perform an impact analysis of KPI improvements. For example, if the KPI is the Days Sales Outstanding (DSO) indicator, the impact analyzer 120 may determine the one-time and/or recurring impact on the bottom line if the business processes 132 could improve the DSO indicator by 10 percent. However, the impact analyzer 120 may encompass any type of impact analysis related to predefined KPIs and/or user-generated KPIs. In one example, the data collector 112 and/or the impact analyzer 120 may obtain the set of KPIs from the KPI database 127, and then obtain the relevant business data from the tenant database necessary to perform the impact analysis. Then, the impact analyzer 120 may perform the impact analysis on the obtained business data.

The root cause analyzer 118 and/or the impact analyzer 120 may store the performance results related to the root cause analysis and/or the impact analysis in a results database 122. Then, the communication manager 109 may provide the performance results, over the network 119, to the benchmarking application 134 for display as the displayed results 140. The displayed results 140 may be arranged and presented to the benchmarking client according to a number of different ways such as tables, graphs, pie charts, etc.

Based on the performance results, a product suggestion unit 124 may provide one or more software products, over the network 119, to the benchmarking application 134 for display as the offered products 142. For example, the product suggestion unit 124 may analyze the performance results and may suggest products that may be of value to the enterprise. For example, if the performance results indicate that the enterprise is under-performing in a certain business area with respect to the peer group 128, the product suggestion unit 124 may suggest additional products that the enterprise may purchase in order to improve performance. In particular, with respect to a particular KPI, if the performance results indicate that the resulting value is below (or above) a threshold value, the product suggestion unit 124 may be configured to offer a certain product in order to improve performance. However, the embodiments encompass any type of method that analyzes performance results, and then suggests one or more products based on the analysis.

Although the results database 122, the customer accounts database 108, the KPI database 127, and the database 116 having the individual tenant databases, are illustrated in FIG. 1 as separate databases, the embodiments encompass any number of databases (including one database) for storing such information. Further, the information (or a portion thereof) associated with these databases may be stored in the in-memory database system as described above.

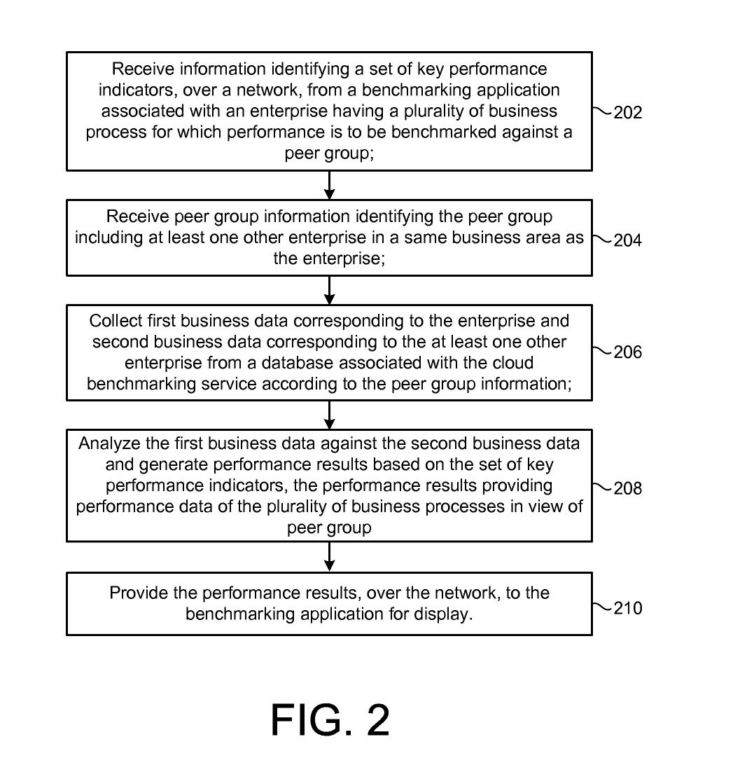

FIG. 2 is a flowchart illustrating example operations of the cloud benchmarking service 104 of FIG. 1 according to an embodiment. Although FIG. 2 is illustrated as a sequential, ordered listing of operations, it will be appreciated that some or all of the operations may occur in a different order, or in parallel, or iteratively, or may overlap in time.

Information identifying a set of key performance indicators may be received over a network from a benchmarking application associated with an enterprise having a plurality of business processes for which performance is to be benchmarked against a peer group (202). For example, the communication manager 109 may receive information, over the network 119, identifying a set of KPIs from the KPI definer 136 of the benchmarking application 134 associated with an enterprise (e.g., Enterprise 1-N). As indicated above, the enterprise includes business processes 132 which the enterprise may wish to benchmark against the peer group 128.

Also, according to the embodiments, a user may select a set of predefined KPIs and/or define his/her own KPIs. Upon selection of the desired KPIs, the communication manager 109 may receive information, over the network 119, identifying the set of KPIs from the benchmarking application 134. Also, the communication manager 109 may receive information, over the network 119, identifying one or more user-defined KPIs. In this case, the KPI generator 126 may generate the full KPIs based on the information received from the benchmarking application 134.

Peer group information identifying the peer group including at least one other enterprise in a same business area as the enterprise may be received (204). For example, the peer group controller 110 may control the peer group 128 based on information provided through the peer group selector 138. For example, the peer group controller 110 may receive peer group information over the network 119 such as the industry information specifying an industry, the SIC code, the regional information specifying a region, the country information specifying a country, the peer information specifying one or more enterprises (1 through N), and/or the enterprise size information indicating a size of an enterprise for inclusion in the peer group. Based on the information provided through the peer group selector 138, the peer group controller 110 may define the peer group 128 for the enterprise to benchmark its business data against.

First business data corresponding to the enterprise and second business data correspond to the at least one other enterprise may be collected from a database associated with the cloud benchmarking service according to the peer group information (206). For example, the data collector 112 may perform the replicate, aggregate, and collection functions associated with uploading the business data from the enterprises associated with the cloud benchmarking service 104. In particular, the data collector 112 may collect the business data when a particular enterprise registers with the benchmarking cloud service 104 or at a later date when the enterprise is ready to have its data uploaded to the cloud. Then, the data collector 112 may store the collected data in the database 116.

Alternatively, the collected data may pass through the data anonymizer 114 (which anonymizes the data), and the anonymized data is stored in the database 116. The database 116 includes the plurality of tenant databases 1-N, where each tenant database may correspond to a different enterprise, and be separated according to tenant separation techniques known in the art. Then, when the cloud benchmarking service 104 begins the benchmarking analysis, the data collector 112 may obtain the relevant business data (or anonymized data) for the benchmarking enterprise from the database 116. Also, the data collector 112 may obtain the business data for the other enterprises in the peer group 128 from the database 116 according to the peer group information.

The first business data may be analyzed against the second business data, and performance results may be generated based on the set of key performance indicators, where the performance results provide performance data of the plurality of business processes in view of the peer group (208). For example, the root cause analyzer 118 may be configured to analyze the business data of the enterprise against the business data of the peer group 128 and generate performance results based on the set of KPIs. The root cause analyzer 118 may utilize any type of root cause analysis technique in the context of benchmarking known to one of ordinary skill in the art. For example, for each KPI, the root cause analyzer 118 may analyze the business data against the business data of the peer group 128, and generate performance results charactering the performance of the business processes 132 such as the under-performance and/or over-performance in relation to the peer group 128.

The performance results may be provided over the network to the benchmarking application for display (210). For example, the communication manager 109 may provide the performance results, over the network 119, to the benchmarking application 134 for display as the displayed results 140. The displayed results 140 may be arranged and presented to the benchmarking client according to a number of different ways such as tables, graphs, pie charts, etc.

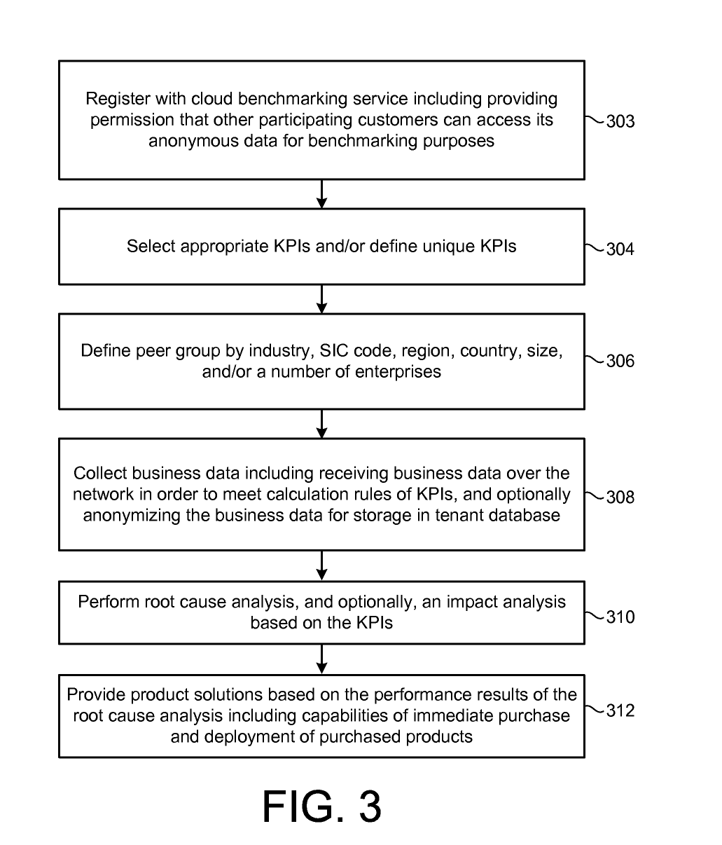

FIG. 3 is a flowchart illustrating example operations of the cloud benchmarking service 104 of FIG. 1 according to another embodiment. Although FIG. 3 is illustrated as a sequential, ordered listing of operations, it will be appreciated that some or all of the operations may occur in a different order, or in parallel, or iteratively, or may overlap in time.

An enterprise may register with the cloud benchmarking service including providing permission that other participating customers can access its anonymous data for benchmarking purposes (303). For example, the registration manager 106 may be configured to register the enterprises for the cloud benchmarking service 104. The registration manager 106 may receive registration information over the network 119 that signs up a particular enterprise (e.g. Enterprise 1-N) for use of the cloud benchmarking service 104. The registration manager 106 may store customer identification information, or any other type of customer information in a customer accounts database 108. For instance, the customer accounts database 108 may store customer information such as customer identification numbers, customer names, location information, as well as any other type of information typically included in a customer account.

The registration manager 106 may also create a tenant database for the newly registered cloud benchmarking client, which may store the uploaded business data and other information related to the benchmarking process. Also, by registering with the cloud benchmarking service 104, the registered enterprise may provide permission that other participating customers can access its data (e.g., anonymous data) for benchmarking purposes.

The appropriate KPIs may be selected and/or unique KPIs may be defined (304). For example, a user may select a set of predefined KPIs and/or define his/her own KPIs. The KPI definer 136 may display a set of predefined KPIs, where the user may select one or more of the displayed KPIs to be used in the benchmarking evaluation. A KPI database 127 may store a plurality of available KPIs to be used in the benchmarking evaluations. Depending on a context of the business processes 132, the peer group 128 and/or the type of enterprise, a KPI generator 126 may select one or more of the predefined KPIs stored in the KPI database 127, and provide the selected KPIs, over the network 119, to be displayed by the KPI definer 136. Then, the user may select one or more of the displayed KPIs, and the KPI generator 126 may receive selection information, over the network 119, from the KPI definer 136, where the selection information indicates one or more selected KPIs. The KPI generator 126 may store the user's selection in the KPI database 127.

Also, the KPI definer 136 may provide an option for the user to create one or more self-defined KPIs. If the user selects this option, the KPI generator 126 may generate the user-defined KPI(s) based on information received via the KPI definer 136 as well as textual definitions and calculation rules associated with the KPI generator 126. In one embodiment, the KPI generator 126 may utilize an analytics tool for generating the user-defined KPI(s) such as the By Design Analytics Wizard developed by SAP. For example, the KPI definer 136 may present a series of interactive user-interfaces that guide the user in creating his/her own KPI(s). The KPI generator 126 may receive the KPI generation information, over the network 119, from the KPI definer 136, and generate the user-defined KPI(s) based on the KPI generation information and the calculation logic associated with the analytics tool. The KPI generator 126 may then store the user-defined KPIs in the KPI database 127.

Peer group may be defined by industry, SIC code, region, country, size, and/or a number of enterprises (306). For example, the peer group controller 110 may control the peer group based on information provided through the peer group selector 138. For example, the peer group controller 110 may receive peer group information over the network 119 such as the industry information specifying an industry, the SIC code, the regional information specifying a region, the country information specifying a country, the peer information specifying one or more enterprises (1 through N), and/or the enterprise size information indicating a size of an enterprise for inclusion in the peer group. Based on the information provided through the peer group selector 138, the peer group controller 110 may define the peer group 128 for the enterprise to benchmark its business data against. In one example, the peer group controller 110 may receive the SIC code, over the network 119, from the peer group selector 138, and the peer group controller 110 may select enterprises having the same SIC code for inclusion in the peer group 128. Also, the user may have the ability to review the selected enterprises, and adjust (e.g., add, delete, change) the selected enterprises.

Business data may be collected including receiving business data over the network in order to meet calculation rules of the KPIs, and optionally anonymizing the business data for storage in tenant database (308). For example, the data collector 112 may perform the replicate, aggregate, and collection functions associated with uploading the business data from the enterprises associated with the cloud benchmarking service 104. For example, the data collector 112 may collect the business data when a particular enterprise registers with the benchmarking cloud service 104 or at a later date when the enterprise is ready to have its data uploaded to the cloud. Then, the data collector 112 may store the collected data in the database 116. Alternatively, the collected data may pass through the data anonymizer 114 (which anonymizes the data), and the anonymized data is stored in the database 116.

A root cause analysis may be performed, and optionally an impact analysis may be performed, based on the KPIs (310). For example, the root cause analyzer 118 may be configured to analyze the business data of the enterprise against the business data of the peer group 128 and generate performance results based on the set of KPIs. For each KPI, the root cause analyzer 118 may analyze the business data against the business data of the peer group 128, and generate performance results charactering the performance of the business processes 132 such as the under-performance and/or over-performance in relation to the peer group 128. Optionally, the impact analyzer 120 may be configured to perform an impact analysis on the business data associated with the enterprise in conjunction with additional business data received from the benchmarking application 134 over the network 119. For example, a cloud benchmarking client may enter and/or release additional business data into the database 116, and the impact analyzer 120 may perform an impact analysis of KPI improvements.

Product solutions may be provided based on the performance results of the root cause analysis including capabilities of immediate purchase and deployment of purchased products (312). For example, based on the performance results, the product suggestion unit 124 may provide one or more software products, over the network 119, to the benchmarking application 134 for display as the offered products 142. For example, the product suggestion unit 124 may analyze the performance results and may suggest products that may be of value to the enterprise. In addition, the user has the capabilities of immediately purchasing the offered products, and these purchased products can be deployed relatively quickly.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A cloud server having a cloud benchmarking service, the cloud server comprising:
at least one processor;
a non-transitory computer-readable storage medium including instructions executable by the at least one processor, the instructions configured to implement,
a communication manager configured to receive information identifying a set of key performance indicators, over a network, from a benchmarking application associated with an enterprise having a plurality of business processes for which performance is to be benchmarked against a peer group;
a peer group controller configured to receive peer group information identifying the peer group including at least one other enterprise in a same business area as the enterprise;
a data collector configured to collect first business data corresponding to the enterprise and second business data corresponding to the at least one other enterprise from a database associated with the cloud benchmarking service according to the peer group information; and
a root cause analyzer configured to analyze the first business data against the second business data and generate performance results based on the set of key performance indicators, the performance results providing performance data of the plurality of business processes in view of the peer group,
the communication manager configured to provide the performance results, over the network, to the benchmarking application for display.

2. The cloud server of claim 1, wherein the set of key performance indicators includes at least one self-defined key performance indicator.

3. The cloud server of claim 1, wherein the peer group information includes at least one of industry information specifying an industry, a Standard Industrial Classification (SIC) code, regional information specifying a region, country information specifying a country, peer information specifying one or more enterprises, and enterprise size information indicating a size of an enterprise for inclusion in the peer group.

4. The cloud server of claim 1, wherein the first business data is stored in a first tenant database and the second business data is stored in a second tenant database, the first and second databases being separate databases.

5. The cloud server of claim 1, further comprising:
a data anonymizer configured to anonymize the first business data and the second business data, wherein the root cause analyzer is configured to analyze the anonymized first business data against the anonymized second business data.

6. The cloud server of claim 1, further comprising:
a registration manager configured to register the enterprise with the cloud benchmarking service including storing registration information associated with the registered enterprise in a customer accounts database.

7. The cloud server of claim 1, further comprising:
an impact analyzer configured to perform an impact analysis on the first business data in conjunction with additional business data received from the benchmarking application over the network.

8. The cloud server of claim 1, further comprising:
a product suggestion unit configured to provide one or more software products for purchase, over the network, based on the performance results.

9. The cloud server of claim 1, further comprising:
an in-memory database system including at least the data collector and the root cause analyzer.

10. A method for benchmarking performed by one or more processors in a cloud benchmarking service, the method comprising:
receiving information identifying a set of key performance indicators, over a network, from a benchmarking application associated with an enterprise having a plurality of business processes for which performance is to be benchmarked against a peer group;
receiving peer group information identifying the peer group including at least one other enterprise in a same business area as the enterprise;
collecting first business data corresponding to the enterprise and second business data corresponding to the at least one other enterprise from a database associated with the cloud benchmarking service according to the peer group information;
analyzing the first business data against the second business data;
generating performance results based on the set of key performance indicators, the performance results providing performance data of the plurality of business processes in view of the peer group; and
providing the performance results, over the network, to the benchmarking application for display.

11. The method of claim 10, wherein the set of key performance indicators includes at least one self-defined key performance indicator.

12. The method of claim 10, wherein the peer group information includes at least one of industry information specifying an industry, a Standard Industrial Classification (SIC) code, regional information specifying a region, country information specifying a country, peer information specifying one or more enterprises, and enterprise size information indicating a size of an enterprise for inclusion in the peer group.

13. The method of claim 10, wherein the first business data is stored in a first tenant database and the second business data is stored in a second tenant database, the first and second databases being separate databases.

14. The method of claim 10, further comprising:
anonymizing the first business data and the second business data, wherein the analyzing step analyzes the anonymized first business data against the anonymized second business data.

15. The method of claim 10, further comprising:
registering the enterprise with the cloud benchmarking service including storing registration information associated with the registered enterprise in a customer accounts database.

16. The method of claim 10, further comprising:
performing an impact analysis on the first business data in conjunction with additional business data received from the benchmarking application over the network.

17. The method of claim 10, further comprising:
providing one or more software products for purchase, over the network, based on the performance results.

18. A computer program product tangibly embodied on a non-transitory computer-readable storage medium and including executable code that, when executed, is configured to cause a cloud server having a cloud benchmarking service to:
receive information identifying a set of key performance indicators, over a network, from a benchmarking application associated with an enterprise having a plurality of business processes for which performance is to be benchmarked against a peer group;
receive peer group information identifying the peer group including at least one other enterprise in a same business area as the enterprise;
collect first business data corresponding to the enterprise and second business data corresponding to the at least one other enterprise from a database associated with the cloud benchmarking service according to the peer group information;
analyze the first business data against the second business data;
generate performance results based on the set of key performance indicators, the performance results providing performance data of the plurality of business processes in view of the peer group; and
provide the performance results, over the network, to the benchmarking application for display.

19. The computer program product of claim 18, wherein the set of key performance indicators includes at least one self-defined key performance indicator.

20. The computer program product of claim 18, wherein the peer group information includes at least one of industry information specifying an industry, a Standard Industrial Classification (SIC) code, regional information specifying a region, country information specifying a country, peer information specifying one or more enterprises, and enterprise size information indicating a size of an enterprise for inclusion in the peer group.
